(19) United States
(12) Patent Application Publication
(10) Pub. No.: US 2009/0021453 A1
(43) Pub. Date: Jan. 22, 2009

(54) FASHION ACCESSORY INCLUDING ALTERNATING LIGHT EMITTING AND NON-LIGHT EMITTING ELEMENTS OF CONSISTENT LENGTHS

(76) Inventor: ZACHARY SMITH, MIAMI LAKES, FL (US)

Correspondence Address: PATENTS ON DEMAND, P.A., 4581 WESTON ROAD, SUITE 345, WESTON, FL, 33331, US

(21) Appl. No.: 11/780,185

(22) Filed: Jul. 19, 2007

(51) Int. Cl. G09G 3/30

(52) U.S. Cl. 345/76

(57) ABSTRACT

The present invention discloses a fashion accessory for nightclub wear. The fashion accessory can include an article of jewelry that includes multiple light-emitting elements, multiple non-light-emitting elements and a binding element. Each of the light-emitting elements can emit light based on electroluminescence, phosphorescence, chemoluminescence, or radioluminescence. The binding element, can connect the light-emitting elements and the non-light-emitting elements together along a linear axis. A length of each light-emitting element and non-light emitting element measured along the linear axis can be approximately equivalent, or at least the lengths of light-emitting elements can be equivalent to each other and lengths of non-light emitting elements can be of equivalent lengths to each other. Further, the light-emitting elements and the non-light-emitting elements can be arranged in an alternating light-dark pattern in which no two light-emitting elements are adjacently positioned and in which no two non-light-emitting elements are adjacently positioned.

### BACKGROUND

1. Field of the Invention

The present invention relates to the field of fashion accessories and, more specifically, to fashion accessories including alternating light emitting and non-light emitting elements of consistent lengths.

In a nightclub environment, participants try to distinguish themselves from others by adopting exotic apparel and accoutrements. As a result, night spots have become a competitive marketplace in which fringe fashions flourish, which is especially true for places specializing in techno or acid music and that cater to young and energetic singles. For example, it is common for club goers to predominately present piercings, tattoos, provocative clothing, and bold or suggestive jewelry. Each night-life aspirant attempts to escalate their status relative to others in this scene that inherently has a psychotropic effect on both perception and behavior relative to societal norms.

Lighting plays a significant factor in a night-club environment, which in turn affects clothing and jewelry of patrons. For example, a portion of a club can be dim or dark, another portion saturated with black light or strobe lights, still another area filled with intermittent multi-colored lights, and the like. Club regulars often use/wear light-manipulating items, such as GLOW STICKS, light emitting diode (LED) pendants, body lights, ultra violent (e.g., black light) active jewelry, and the like.

Conventional light-manipulating jewelry has a cheap, novelty look and is generally distributed through novelty stores and Web sites. There is a distinct disconnect between often expensive trendy clubs and relatively cheap/novelty accessories commonly worn at these clubs. Further, most of the light-manipulating items have a limited visual appeal to a night environment only. For example, most items that fluoresce have a milky white appearance when displayed in well-lit environments, which is not particularly attractive. Other active jewelry, such as LED pendants, are similarly only advantageously displayed in dim lighting conditions making them unsuitable for general daytime wear. As a result, fashion conscious club devotees are often forced to change their clothing and accessories significantly before attending a night spot, which can be inconvenient to club goers who spontaneously decide to go to a night spot while they are already out-on-the-town.

What is needed is a more upscale variant of light-manipulating accessories that is targeted to night club clientele. Ideally, the upscale accessories would be fashionable in well lit conditions as well as dimly lit or specially lit conditions. It would also be advantageous for the upscale accessories to have a distinctive look-and-feel, which would permit a manufacturer to establish a characteristic fashion niche. Creating a niche can permit a trend-setting manufacturer to reap pecuniary rewards from their innovations due to a premium purchaser perceived value being associated with items produced by that manufacturer. That is, a distinctive look would assist an accessory manufacturer to become an upscale source of choice (i.e., to become the “PRADA” or “GUCCI”) for the night-club scene. No known apparel manufacturer has distinguished themselves in this manner. That is, presently no known dub fashion accessories exhibit alternating patterns of light emitting and non-emitting elements.

### SUMMARY OF THE INVENTION

The present invention discloses a method of ordering light-emitting elements in a distinctive alternating pattern in a fashion accessory in accordance with an embodiment of the inventive arrangements disclosed herein. The fashion accessory can be specifically designed as a night club adornment, which appears as alternating bands of light and dark components when worn in night club lighting or in dark environments. The light and dark components can be arranged so that each light band is approximately the same length as other light bands and each dark band is the same length as other dark bands. Each light-emitting element can be shaped as decorative ornaments suitable for a club environment, such as a skull, a heart, a nut, and the like. Various scientific principles can be utilized to create the emitted light including electroluminescence, photoluminescence, chemoluminescence, and radioluminescence. Dark or non-light-emitting elements can be interspersed with the light-emitting elements and can similarly be shaped as decorative ornaments.

In one embodiment, the fashion accessory can be designed to be visually appealing in both a dark environment and a light environment. For example, light emitting ornaments can be both phosphorescent and fluorescent so that in light conditions a fluorescent coloration is observed and in dark conditions a different phosphorescent coloration is observed.

The present invention can be implemented in accordance with numerous aspects consistent with the material presented herein. For example, one aspect of the present invention can include a fashion accessory including multiple elements arranged in serial that when interconnected an approximately continuous line of interconnected elements is formed. The elements can include two or more light elements and two or more dark elements. Each interior light element can be adjacent to two dark elements when interconnected and each interior dark element can be adjacent to two light elements. Interconnected lengths of each light element can be approximately equivalent to each other and interconnected lengths of each dark element can be approximately equivalent to each other. Interconnected lengths for each element can be defined as a length in a direction approximately parallel to the continuous line. Each light element can be an element that emits light. Each dark element can be an element that does not emit light. An emission of light from each light element can be caused by electroluminescence, photoluminescence, chemoluminescence, or radioluminescence.

Another aspect of the present invention can include an article of jewelry that includes a jewelry body, two or more coupling linkages, and two or more decorative ornaments. The jewelry body can be approximately linear in at least one direction when worn. The coupling linkages can be attached to the jewelry body and can each permit a decorative ornament to be attached to the coupling linkage. The decorative ornaments can include light-emitting ornaments and non-light-emitting ornaments. Each light-emitting ornament can emit light based on electroluminescence, phosphorescence, chemoluminescence, or radioluminescence. The article of jewelry can be constructed to permit end-users to rearrange the decorative ornaments in user desired patterns. One of these patterns can include an alternating light-dark pattern in which no two light-emitting ornaments are adjacently positioned and in which no two non-light-emitting ornaments are adjacently positioned.

Still another aspect of the present invention can include an article of jewelry that includes multiple light-emitting elements, multiple non-light-emitting elements, and a binding element. Each of the light-emitting elements can emit light based on electroluminescence, phosphorescence, chemoluminescence, or radioluminescence. The binding element can connect the light-emitting elements and the non-light-emitting elements together along a linear axis. A length of each light-emitting element and non-light emitting element measured along the linear axis can be approximately equivalent. Further, the light-emitting elements and the non-light-emitting elements can be arranged in an alternating light-dark pattern in which no two light-emitting elements are adjacently positioned and in which no two non-light-emitting elements are adjacently positioned.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating characteristics of a fashion accessory having multiple light, and dark elements alternated in a consistent pattern in accordance with an embodiment of the inventive arrangements disclosed herein.

FIG. 2 is a set of diagrams illustrating various contemplated configurations for a fashion accessory having an alternating light/dark pattern in accordance with the inventive arrangements disclosed herein.

FIG. 3 is a schematic diagram illustrating that elements (specifically those shaped as decorative ornaments) of a fashion accessory can be arranged in various ways to achieve an end result of an alternating light/dark pattern in accordance with an embodiment of the inventive arrangements disclosed herein.

FIG. 4 is a diagram visually illustrating a few different embodiments for the fashion accessory described in FIG. 1.

### DETAILED DESCRIPTION OF THE INVENTION

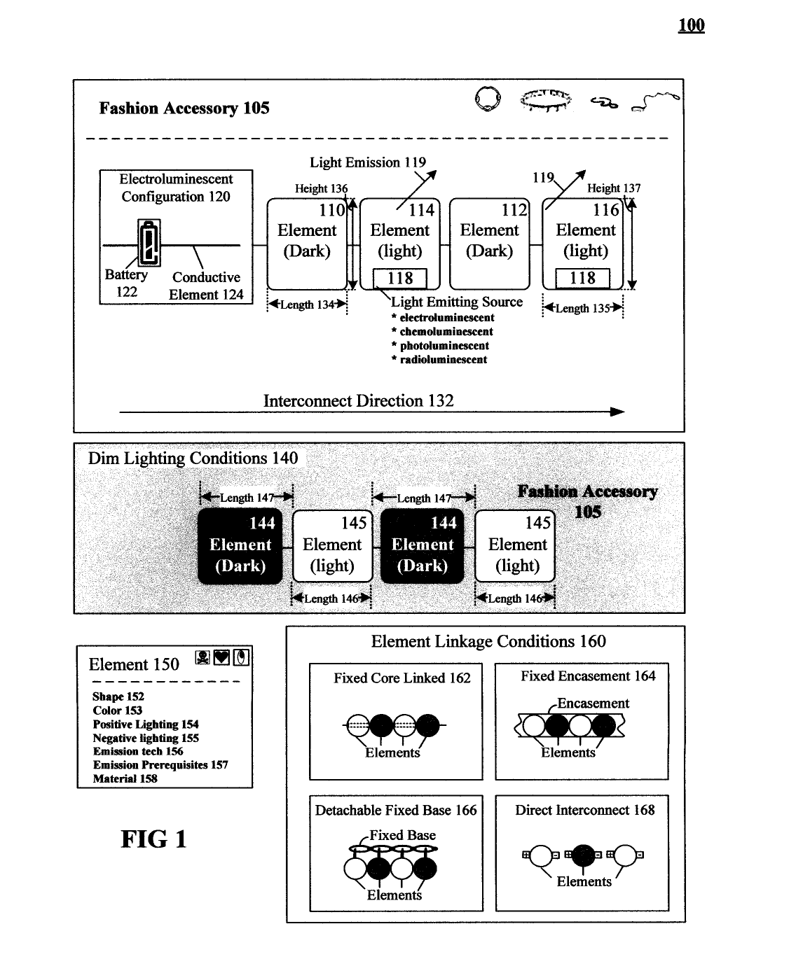

FIG. 1 is a schematic diagram 100 illustrating characteristics of a fashion accessory 105 having multiple light 114-116 and dark 110-112 elements alternated in a consistent pattern in accordance with an embodiment of the inventive arrangements disclosed herein. The fashion accessory 105 can be particularly suited for a night club environment, which often has lighting beneficial for showcasing the alternating light/dark pattern produced by the accessory 105. The accessory 105 can, of course, be worn in any context. Any number of elements 110-116 can be included in the fashion accessory 105. Moreover, the elements 110-116 can extend for an entire length of the accessory 105 or can extend for only a portion of the accessory's length. A light element 114-116 is defined as an element able to emit light 119 and a dark element 110-112 is one that does not emit light.

The fashion accessory 105 can be an adornment able to be worn or carried, which is not considered clothing. For example, the fashion accessory 105 can include an article of jewelry, such as a bracelet, an anklet, a necklace, a chain, a choker, a collar (pet or human), a dangling earring, a watch, a body piecing, and the like. The fashion accessory 105 can also include a belt, a headband, a leash, a keychain, a purse handle, a camera/cell phone strap, a whip, a surfboard rope, and the like.

The elements 110-116 can have approximately consistent lengths 134-135 along an interconnect direction 132, which serves as a reference axis. That is, each light element 114, 116 will have approximately the same length 135 as other light elements 114, 116 and each dark element 110-112 will have approximately the same length 134 as other dark elements. Heights 136, 137 and widths (not shown) of the elements 110-116 can be consistent among all the elements 110-116, can be consistent among elements having similar light emission characteristics (e.g., light or dark elements), and/or can vary randomly or in accordance with a desired pattern between the elements 110-116.

Approximately equivalent lengths as used in this context refers to any set of lengths having an overall variance among length consistent elements 110-116 of less than fifteen percent. This slight variance permits the perception of equivalent light/dark spaces to be maintained, while permitting some leeway for design, shape, and/or ornamentation purposes. Further, it permits some flexibility for element 110-116 movement along the interconnect direction 132. Once the variance between like elements 110-116 exceeds fifteen percent, a consistency of an alternating pattern between light/dark spaces is compromised.

Perceptual light/dark spacing can, however, change based on a distance of an observer to an accessory 105 wearer, based upon the relative sizes of the light/dark elements 110-116, based upon a viewer's eyesight, and the like. For instance, at medium distances, such as twenty feet from a necklace wearing individual, where the necklace is a fashion accessory 105 having elements approximately a half inch in length, a variance among approximately equal elements can be reduced to ten percent to maintain the desired perceptual qualities. In another example, at extremely close distances, such as within a foot of the fashion accessory 105, a perceptual threshold for maintaining an illusion of equivalent spacing can be reduced to a five percent variance among elements.

Additionally, the interconnect direction 132, which is a reference direction for purposes of defining a dimension of the elements 110-116 referred to as a length 134-135 is “approximately” a linear direction. That is, the interconnection direction 132 will not actually be a straight line, but will generally have at least some curvature. For example, the fashion accessory 105 can be a bracelet designed to be worn around a wrist, which results in the direction 132 being an oval shape. A necklace similarly has a curvature, consistent with a curvature for placement about a wearer's neck. An actual geometric shape of the interconnect direction 132 will depend upon characteristics of the accessory 105 itself and should be broadly construed.

Maintaining approximately consistent lengths 146, 147 based upon light emission characteristics of elements results in a repeating pattern of light/dark spaces when the fashion accessory 105 is placed in dim lighting conditions 140. In other words, elements 145, which emit light, are clearly and proximately seen in dim lighting conditions 140, while non-emitting elements 144 are visually de-emphasized or hidden. A viewer of the fashion accessory 105 largely sees a set of lit elements 145, each having a consistent length 146, separated by dark spaces, which also have a consistent length 147.

It should also be noted that a number of total light/dark alternating elements 110-116 necessary to establish a characteristic and repeating pattern can vary by implementation specifics. For example, seven or more total elements 110-116 (e.g., three dark and four light or four dark, and three light) can be a minimal set of elements for a necklace or bracelet fashion accessory 105 in order to firmly establish a perceptual pattern of light/dark via the accessory 105. In another example, a set of dangling earrings (105) can have a minimal set of three elements 110-116, so long as the earrings are worn with at least one matching accessory, which has live or more total elements. Further, when light emitting elements 114, 116 have different characteristics from each other, such as having different light emitting colors from one another, the total number of elements 110-116 for the accessory 105 can be increased to ensure a repeating pattern is firmly established. Generally, when elements 110-116 have extremely similar characteristics 152-158, fewer total elements are necessary to unambiguously establish a characteristic and distinctive light/dark pattern for the accessory 105.

Each light element 114-116 of accessory 105 can utilize a light emitting source 118 to produce light emissions 119. The light emissions 119 can be within a portion of the electromagnetic spectrum that is able to be perceived by a human eye, which includes electromagnetic radiation having wavelengths between approximately 380 nm and approximately 760 nm. Light emissions 119 can be produced actively by expending internally produced energy or semi-passively by absorbing ambient energy and re-emitting it. The emitted electromagnetic radiation can be a different wavelength than that of the absorbed radiation. Emissions 119 can result from electroluminescent, chemoluminescent, photoluminescent, and/or radioluminescent reactions.

Electroluminescence is an optical and electrical phenomenon where a material emits light in response to an electric current passed through it, or to a strong electric field. That is, electroluminescence is the result of radiative recombination of electrons and holes in a material (usually a semiconductor). The excited electrons release their energy as photons. Prior to recombination, electrons and holes are separated either as a result of doping of the material to form a p-n junction (in semiconductor electroluminescent devices such as LEDs), or through excitation by impact of high-energy electrons accelerated by a strong electric field (as with the phosphors in electroluminescent displays).

Electroluminescent configurations 120 will generally require the fashion accessory 105 to include a battery 122 and a conductive element 124. The conductive element 124 can be insulated to prevent inadvertent discharge that shocks a wearer. Further, the conductive element 124 can be contained within a core binding element of the accessory 105. For example, in one embodiment (linkage 162) each element 134 can be centrally bored along the interconnect direction 132 and a flexible binding wire/string can pass through element centers to connect the elements 110-116.

The battery 122 (e.g., a small “watch” battery) can be a component that is an energy source for providing electrical current to a series of electrical lights (e.g., LEDs) contained in the fashion accessory 105. The battery 122 can convert chemical energy, such as that stored in a dry cell, to electrical energy. The electrical energy can travel to light elements 114-116 from the battery 122 via a conductive element. A continuous electrical circuit can be formed that includes the battery 122, the conductive element 124 and the light elements 114-116, when the accessory 105 is worn. For example, a magnetic or other conductive clasp (not shown) can be used to connect opposing ends of the fashion accessory 105, while simultaneously completing the electrical circuit. In an electroluminescent configuration 120 an optional on/off switch (not shown) and/or an optional ambient light detecting toggle (not shown) can be included in the electrical circuit to permit a user or environmental lighting conditions to selectively change the light elements 114-116 between an on state and an off state.

Chemoluminescence is an emission of light without a significant emission of heat as the result of a chemical reaction. Chemoluminescence usually involves the oxidation of an organic compound, such as luminol or acridinium esters, by an oxidant, such as hydrogen peroxide or hypochlorite. Chemoluminescent reactions occur in the presence of catalysts, such as alkaline phosphatase, horseradish peroxidase, metal ions or metal complexes. Chemicals are often consumed or altered during a chemoluminescent reaction, which causes the light emissions 119 to occur only for a duration of the underlying, photon generating chemical reaction. For example, a GLOW STICK uses chemoluminescent reactions, which are triggered when the GLOW STICK is bent, causing an interior glass vial to break, which permits chemicals inside the glass vial to combine with surrounding chemicals that together result in an a short-term chemoluminescent reaction.

Photoluminescence is a process in which a chemical compound absorbs photons or ambient electromagnetic radiation, thus jumping to a higher electronic energy state, and then radiates photons back out, returning to a lower energy state. Photoluminescence is luminescence arising from photoexcitation. Two distinct forms of photoluminescence include fluorescence and phosphorescence.

It is possible to construct light elements 114-116 so that the elements 114-116 are both fluorescent and phosphorescent using many underlying techniques, such as those expressed in U.S. Pat. No. 5,172,937 titled “Combined Fluorescent and Phosphorescent Structures,” U.S. Pat. No. 5,569,317 titled “Fluorescent and Phosphorescent Tagged Ink for Indicia,” U.S. Pat. No. 7,221,333 titled “Display Panel with Phosphorescent and Fluorescent Pixels,” and the like. Using both fluorescent and phosphorescent light elements 114-116 can be advantageous as it permits accessory 105 elements to have two different fashionable and distinct looks that automatically change based upon surrounding lighting conditions. This is opposed to the traditional milky white appearance of most conventional glow-in-the-dark (e.g., phosphorescent) substances, which are not visually appealing in many situations relating to use as a fashion accessory 105.

Fluorescence is a luminescence that is mostly found as an optical phenomenon in which the molecular absorption of a photon triggers the emission of another photon with a longer wavelength. Fluorescent reactions generally have an extremely short period between absorption and emission, such as in the order of approximately ten nanoseconds. Fluorescent colors are generally intense, brilliant colors that are often referred to as Day-Glo colors.

Unlike fluorescence, a phosphorescent reaction does not immediately re-emit the radiation it absorbs, but instead slower releases absorb radiation at a lower intensity for up to several hours. The slower time scales of the re-emission are associated with “forbidden” energy state transitions in quantum mechanics. In a phosphorescent reaction, absorbed photon energy undergoes an unusual intersystem crossing into an energy state of higher spin multiplicity, usually a triplet state. As a result, the energy can become trapped in the triplet state with only quantum mechanically “forbidden” transitions available to return to the lower energy state. These transitions occur but are kinetically unfavored, which causes these transitions to progress at relatively slow time increments. Phosphorescent materials can have triplet lifetimes up to minutes or even hours, which allows the materials to effectively store light energy in the form of very slowly degrading excited electron states. If phosphorescent quantum yield is high, phosphorescent materials can release significant amounts of light over long time periods. Phosphorescent materials or glow-in-the-dark materials can be automatically charged by exposure to light.

Radioluminescence is the phenomenon by which luminescence is produced in a material by the bombardment of ionizing radiation such as beta particles. An example of a common radioluminescent material is the tritium-excited luminous paints commonly used on watch dials and gun sights, another is a mixture of radium and copper-doped zinc sulfide paint used historically to paint clock dials. Many radioluminescent substances exist that are able to be worn by humans next to the skin without adverse affects.

Element 150 is a more detailed representation of a fashion accessory element 110-116. Each element 150 can have numerous characteristics, such as shape 152, color 153, positive lighting characteristics 154, negative lighting characteristics 155, emission technology 156, emission prerequisites 157, material 158, and the like. Each of these characteristics can vary from element 110-116 to element 110-116.

The shape 152 refers to a general shape of the element. The shapes 152 can include standard etchings, laser etchings, writings, graphics, and overall exterior surface shape of the element 150. In one embodiment, different shapes 152 can cause elements 150 to be considered separate charms for the fashion accessory 105. The shape 152 can determine general aesthetic characteristics that cause the element 150 to be considered a distinctive decorative ornament. The color 153 characteristic can refer to a perceived color of a charm, which can be multicolored and color variable due to light emission characteristics.

The positive and negative lighting characteristics 154-155 refer to element 150 behavior in a brightly lit environment and in a dimly lit or dark environment. For example, a fluorescent/phosphorescent element will have dominant fluorescent coloration/emissions in a positive lighting environment 154 and dominant phosphorescent coloration/emissions in a negative lighting environment 155. Light emissions need not be consistent for the entire element 150. For example, an electroluminescent element 150 can have multiple different colored LEDs, which each emit light in a positive light environment 154. Additionally the lighting characteristics 154-155 can indicate whether light emissions are consistent or intermittent (i.e., having a constantly “on” or a blinking characteristic).

The emission technology 156 can refer to a type of reaction used to generate light emissions if any. Emission technology 156 represents whether an element 150 is electroluminescent, chemoluminescent, photoluminescent, and/or radioluminescent.

Emission prerequisites 157 refers to a set of characteristic conditions required for light emissions to be produced by the element 150 and/or perceived by bystanders. For example, in an electroluminescent situation, an on/off switch may be present and a prerequisite 157 for emissions can be that the element 150 is in an on state. In a phosphorescent situation, a minimum “charge time” for absorbing ambient radiation can be considered a prerequisite 157.

The material 158 can refer to chemical composition and/or structural arrangements of the element 150. For example, an electroluminescent and/or chemoluminescent element 150 can include an emission component, such as a LED or a liquid, and a containing component, which necessarily requires the containing component to be a transparent or translucent material 158.

The various elements 110-116 can be attached to the fashion accessory 105 in various manners, which can be fixed (162-164) at manufacture time or can be user adjustable (166-168). Element linkage conditions 160 pictorially express that various linking conditions are contemplated for the fashion accessory 105. The conditions 160 are for illustrative purposes only and the invention is not to be limited in this regard.

One common linkage arrangement 162 is for each element to include a hole, through which a binding element 130, such as a string, wire, or chain, passes. Terminal ends of the binding element 130 can optionally include a clasp that allows the ends to connect. Alternatively, the binding element can be flexible or elastic to permit the fashion accessory 105 to be temporarily stretched over an appendage (e.g., a hand for a bracelet) and into a desired position (e.g., surrounding a wrist).

The fixed encasement arrangement 164 can include a continuous outer surface that encompasses and contains the light and dark elements. For example, a transparent plastic tube can be used as a continuous outer surface within which elements are placed. In one contemplated embodiment, the outer surface can have sections that are transparent or translucent and other sections that are opaque. These sections can result in related sections being considered light elements or dark elements. For example, if a light emitting liquid (chemoluminescent) is uniformly dispersed inside a continuous exterior surface (e.g., glass or plastic tubing), and if this exterior surface alternates its properties so that every other segment is transparent or opaque, then the exterior surface is actually part of the “elements” and is used to define whether an element is a light element (corresponding to a transparent section) or a dark element (corresponding to an opaque section).

The detachable element/fixed base arrangement 166 represents a typically “charm” bracelet, where detachable ornaments can be clipped onto a base chain. Arrangement 166 permits a market separation between base element (e.g., chain) sales and ornament (e.g., detachable element) sales. Additionally, by nature, an end-user can adjust the relative arrangements of ornaments as desired. Hence, a user need not create an alternating arrangement of light/dark elements as shown for the fashion accessory 105 by elements 110-116. Any fashion accessory 105 designed to permit a user to create an alternating configuration of light/dark elements is to be considered within the scope of the present invention.

The no base/direct interconnect arrangement 168 represents a fashion accessory having a series of elements that can directly attach to other elements. That is, each element includes an interconnecting link to other elements. For example, one side of an ornament can include a positively charged magnet and an opposing side a negatively charged magnet, which permits sequentially positioned elements to automatically link to each other. In another example, one end of an ornament can include a clip and an opposing end a link, which clips from one ornament, can be attached to loops of an adjacent ornament.

It should be appreciated that derivatives exist to the linkage conditions 160 that cause normally immutable arrangements to be configurable and normally configurable configurations to be fixed. For example, do-it-yourself bead/jewelry kits can be one element adjustable variation of the fixed core arrangement 162. Similarly, links connecting various elements to a “charm bracelet” can be welded links, which represents a fixed derivative for the detachable fixed base 166 arrangement.

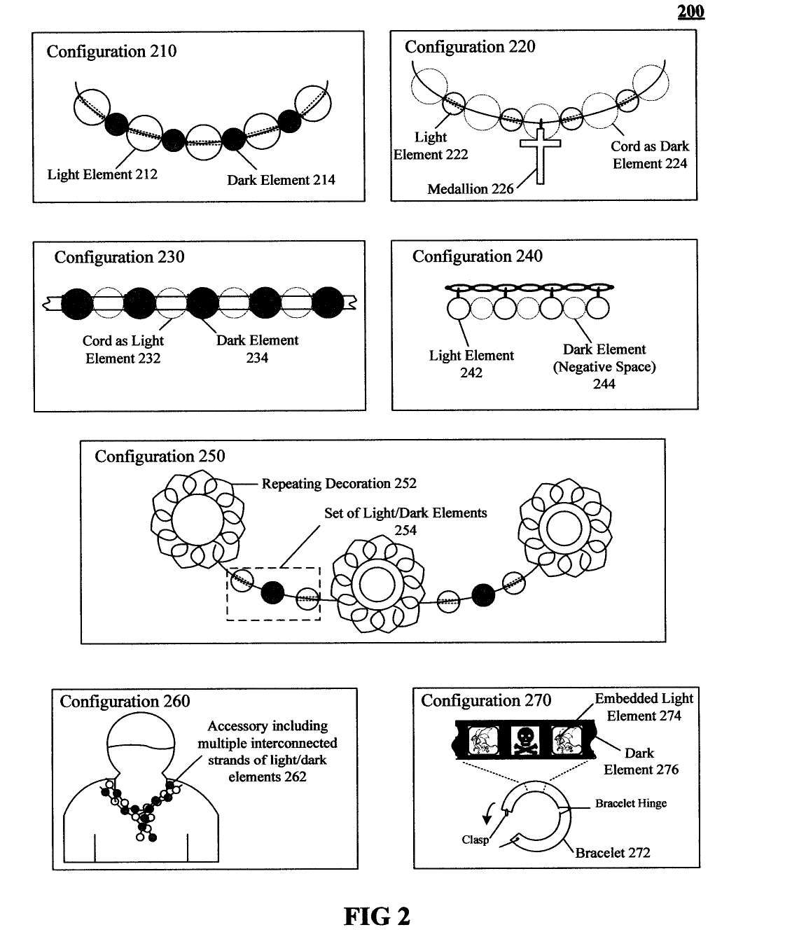

FIG. 2 is a set of diagrams 200 illustrating various contemplated configurations 210-270 for a fashion accessory having an alternating light/dark pattern in accordance with the inventive arrangements disclosed herein. Each of the configurations of diagram 200 can be for a fashion accessory consistent with system 100.

Configuration 210 shows a fashion accessory that includes light elements 212 adjacent to dark elements 214, where each light element 212 is larger than each dark element 214. The elements 212 and 214 can be configured to slide along a binding element (e.g., a string or cord running through a core of each element).

Configuration 220 shows that a fashion accessory can optionally include one or more medallions 226, which are not considered to be part of the light/dark elements for purposes of generating alternating light/dark patterns. Additionally, configuration 220 shows that the light element 222 can be an ornament, while the dark element 224 can be a section of cord (non-light emitting) to which the light elements 222 and optional medallion 226 is attached.

Configuration 230 shows the opposite, where each dark element 234 can be an ornament and each light element 232 can be a section of cord (light emitting) to which the dark elements 234 are attached.

Configuration 240 illustrates that a set of light elements 242 can dangle or hang off of a supporting member, such as a chain. The set of dark elements 244 can be negative spaces, which have been intentionally left blank. In a dark environment, the negative spaces 244 will be perceptually similar to a physical dark element, which is not actually present in the configuration 240.

Configuration 250 shows that a set of light/dark elements 254 can be presented in a repeating pattern, which is periodically separated by a repeating decoration 252. The repeating nature to the set 254 results in a perception of alternating light/dark elements for a fashion accessory, even when a number of elements in the set 254 is relative small, such as three.

Configuration 260 shows an accessory that includes multiple interconnected strands of light/dark elements 262.

Configuration 270 shows a hinged bracelet 272 implementation, where light emitting elements 274 are embedded in the bracelet and where dark elements 276 are formed by the bracelet material in which light elements 274 are embedded.

It should be appreciated that the configurations 210-270 are not intended to be exhaustive and that the invention is not to be construed as limited to specific details shown in diagram 200. For example, one additional contemplated configuration (not shown) can include a set of elements partially obscured by a covering item, such as a set of light/dark elements on a dangling earring, which are partially obscured by feathers that are part of the dangling assemblage.

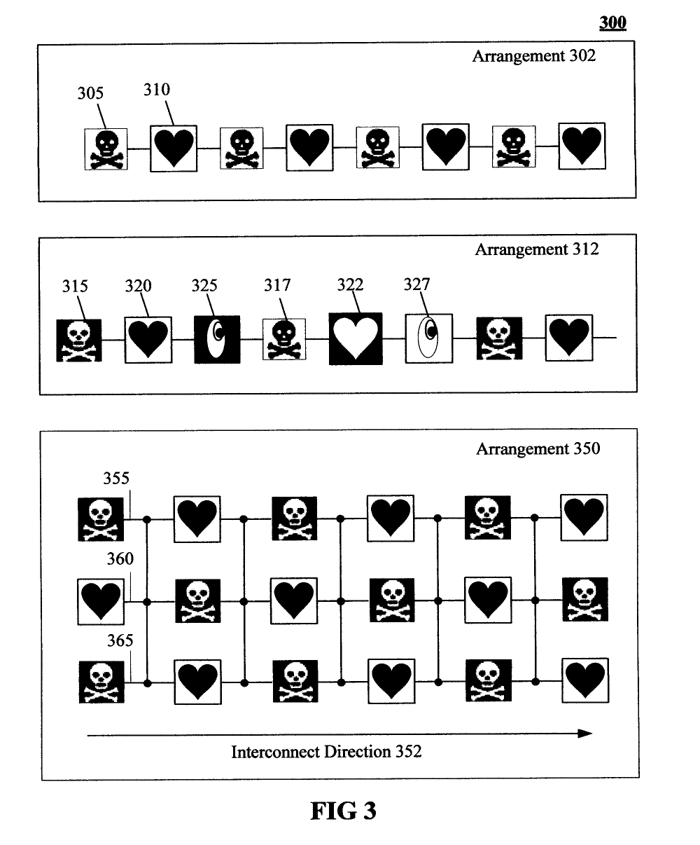

FIG. 3 is a schematic diagram 300 illustrating that elements (specifically those shaped as decorative ornaments) of a fashion accessory can be arranged in various ways to achieve an end result of an alternating light/dark pattern in accordance with an embodiment of the inventive arrangements disclosed herein. The ornament arrangements shown in diagram 300 can apply to a fashion accessory 105 shown in system 100.

In one arrangement 302, distinctive ornamental shapes can be directly associated with a light-emitting nature of the ornament. For example, each light emitting ornament 305 can be shaped as a skull and crossbones and each non-light emitting ornament 310 can be shaped as a heart.

In another arrangement 312, a repeating series of ornamental shapes can be used, where both light emitting and non-light emitting ornaments use each of the repeating shapes. The illustrated ornamental shapes include a skull 315, a heart 320, and a nut (e.g., a Hawaiian kukui nut) 325. Every other one of each ornament shape can vary as to whether it emits light or not. That is, skull 315 can be a dark element, which does not emit light and skull 317 can be a light element that does emit light. Heart 320 can emit light, while heart 322 can be non-emitting. Additionally, nut 325 can be a non-emitting element, yet nut 327 can emit light. The important characteristic of arrangement 312 is that every other adjacent ornament 315-327 is light emitting. Further, each light emitting ornament has approximately the same length relative to an interconnect reference axis as does each non-light emitting ornament, as detailed in system 100.

Arrangement 350 shows that a fashion accessory can include more than one row 355, 360, and 365 of ornaments (or elements) relative to an interconnect direction 352. In each row 355, 360, and 365, an alternating light/dark pattern of ornaments can be established. Adjacent rows of ornaments 355-365 can be positioned to create different overall visual effects. As shown, a vertical (relative to direction 352) checker-board pattern can be created by alternating light/dark ornaments vertically among adjacent rows 355-365. In a different configuration (not shown), row 360 can be positioned so that a consistent vertical line of dark ornaments and of light elements is established. In still another configuration (not shown), each ornament of row 360 can be a light emitting element and/or each ornament of row 360 can be a non-light emitting ornament. Although three rows are shown in arrangement 350 any number of rows can be utilized depending upon what fashion effect is desired.

It should be appreciated that the shapes and arrangements shown used in diagram 300 are for illustrative purposes only and that the invention is not to be construed as limited in this regard. Ornaments (e.g., fashion accessory elements) can be any shape, size, or color. Further, ornaments can have different light emitting properties from each other and when emitting light can utilize different scientific principles from those used by other ornaments.

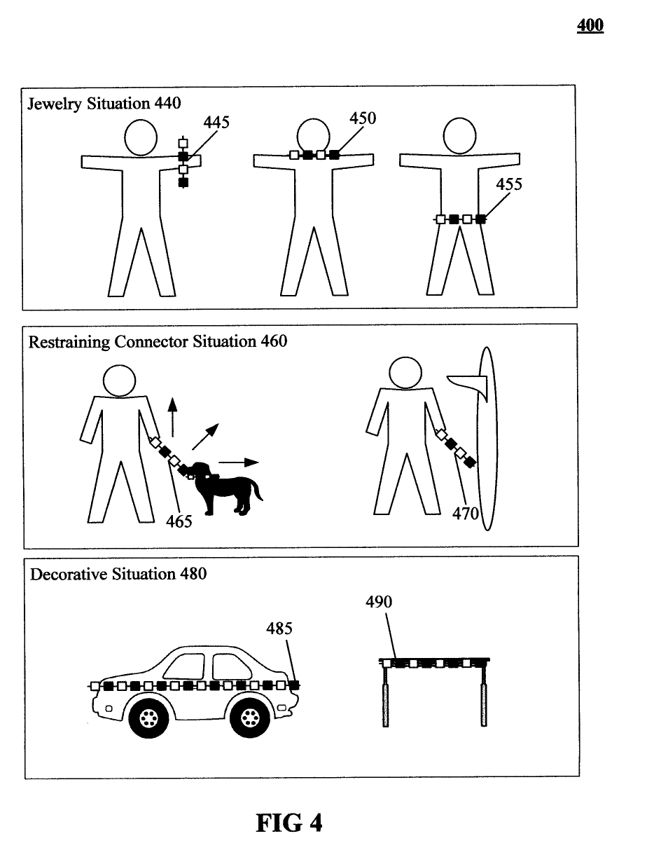

FIG. 4 is a diagram 400 visually illustrating a few different embodiments for the fashion accessory described in FIG. 1. The embodiments of diagram 400 are not intended to be exhaustive and are additionally not necessarily drawn to scale. Diagram 400 is included to emphasize that the invention is adaptable for use in many divergent situations. In each of these divergent situations, an underlying fashion accessory is able to maintain its unique characteristics (e.g., consistently spaced light/dark elements), as defined by the inventive arrangements disclosed herein.

In a jewelry situation 440, a fashion accessory 445-455 as described herein can be worn about numerous body parts. For example, the fashion accessory can be worn around a wrist 445, around a neck 450, around a waist 455, and the like. When worn as jewelry 440 the fashion accessory 445-455 may or may not have a non-decorative purpose. For instance, when worn around the wrist 445, the fashion accessory can be a bracelet that is purely decorative or can be a watch, which serves a function in addition to its decorative purpose.

In situation 460, the fashion accessory 465-470 can connect an owner to another object, possibly to assert control over that object. For example, the fashion accessory 465 can be a leash connecting the owner to a pet. In another example, the fashion accessory 470 can be used to connect a surfboard and a surfer to each other.

Decorative situation 480 is included to emphasize that as used herein, the definition of a fashion accessory 485-490 can be broadly construed to include items other than those worn or handled by a user. For example, a fashion accessory 485 can be a distinctive pin-striping of an automobile. In another example, the fashion accessory 490 can be a distinctive edging for a table or other furnishing. Using the fashion accessory 490 to decorate a furnishing or environment object can help produce party atmosphere or club-effect. The accessories 485-490 can be permanently affixed to their underlying objects (e.g., car or table) or can be designed to be a temporary affixation that is easily removed. For instance, the pin-striping 485 can include a weak adhesive backing that permits it to be easily attached and subsequently removed from a car.

This invention may be embodied in other forms without departing from the spirit or essential attributes thereof. Accordingly, reference should be made to the following claims, rather than to the foregoing specification, as indicating the scope of the invention.

What is claimed is:

1. A fashion accessory comprising:
a plurality of elements arranged in serial that when interconnected form an approximately continuous line of interconnected elements,
said elements comprising a plurality of light elements and a plurality of dark elements, wherein each light element is adjacent to two dark elements and each dark element is adjacent to two light elements along the continuous line, wherein an interconnect length of each light element is approximately equivalent, and wherein an interconnect length of each dark element is approximately equivalent, wherein the respective interconnect lengths are each element lengths in a direction approximately parallel to the continuous line, wherein a light element is an element that emits light, wherein a dark element is a element that does not emit light, and wherein an emission of light from each light element is caused by at least one of electroluminescence, photoluminescence, chemoluminescence, and radioluminescence, and wherein an approximately equivalent interconnect length is a length having a total variance among similar elements of fifteen percent or less.

2. The fashion accessory of claim 1, wherein said interconnect lengths for light and dark elements are approximately equivalent to each other.

3. The fashion accessory of claim 1, wherein said interconnect lengths for light elements are different from interconnect lengths for dark elements.

4. The fashion accessory of claim 1, wherein each light element is a decorative ornament having a distinctive shape.

5. The fashion accessory of claim 4, wherein the plurality of light elements comprise a plurality of different distinctive shapes.

6. The fashion accessory of claim 5, wherein each of the dark elements is decorative ornaments having the same plurality of different distinctive shapes as the light elements.

7. The fashion accessory of claim 4, wherein light elements of different distinctive shapes are able to be separately purchased by consumers in accordance with consumer preferences, wherein said light elements designed to be combined by the consumers with dark elements so that the consumers are able to customize the fashion accessory, whereby the light and dark elements are effectively distinctive charms able to be combined and attached to the fashion accessory as desired.

8. The fashion accessory of claim 7, wherein the emissions of light are caused by electroluminescence, wherein the fashion accessory includes a battery, wherein each of the plurality of elements interconnect through a detachable coupling, wherein when interconnected a continuous electronic circuit including each of the light elements and the battery is formed.

9. The fashion accessory of claim 1, wherein the fashion accessory is at least one of a bracelet, a watch, an anklet, a necklace, a headband, a belt, a purse strap, a pet collar, a leash, a surfboard rope, a chain, a body piercing, a earring, and a ring.

10. The fashion accessory of claim 1, wherein the plurality of elements comprises at least seven elements.

11. The fashion accessory of claim 1, wherein different ones of the plurality of light elements emit light in different manners, wherein the different manners include at least two of electroluminescence, phosphorescence, chemoluminescence, and radioluminescence.

12. The fashion accessory of claim 1, wherein each light element is both phosphorescent and fluorescent.

13. The fashion accessory of claim 1, further comprising:
a continuous exterior surface enveloping the light elements and the dark elements, wherein at least a portion of the exterior surface corresponding to each of the light elements is at least one of translucent and transparent.

14. An article of jewelry comprising:
a jewelry body that is approximately linear in at least one direction when worn;
a plurality of coupling linkages, each coupling linkage being configured to permit a decorative ornament to be attached to the coupling linkage;
a plurality of said decorative ornaments comprising a plurality of light emitting ornaments and a plurality of non-light-emitting ornaments, wherein each light-emitting ornament emits light based on at least one of electroluminescence, phosphorescence, chemoluminescence, and radioluminescence, wherein said article of jewelry is constructed to permit end-users to rearrange the decorative ornaments in user desired patterns, wherein one of these patterns includes an alternating light-dark pattern in which no two light-emitting ornament are adjacently positioned and in which no two non-light-emitting ornaments are adjacently positioned.

15. The article of jewelry of claim 14, wherein each light-emitting ornament has an interconnect length that is approximately equivalent to that of other light-emitting ornaments, wherein each interconnect length is a length of the element in a direction approximately parallel to the at least one direction as determined when the light-emitting ornaments are coupled to a coupling linkage, and wherein an approximately equivalent interconnect length is a length having a total variance among similar elements of fifteen percent or less.

16. The article of jewelry of claim 15, wherein each non-light emitting ornament has an interconnect length that is approximately equivalent to that of other non-light-emitting ornaments, wherein each interconnect length is a length of the element in a direction approximately parallel to the at least one direction as determined when the non-light-emitting ornaments are coupled to a coupling linkage.

17. The article of jewelry of claim 16, wherein the interconnect lengths of light-emitting ornaments and of non-light-emitting ornaments are approximately equivalent.

18. The article of jewelry of claim 14, wherein the article of jewelry is retailed so that the different ones of the plurality of decorative ornaments are able to be purchased in retail transactions different from retail transactions in which the jewelry body is purchased.

19. An article of jewelry comprising:
a plurality of light-emitting elements that emit light based on at least one of electroluminescence, phosphorescence, chemoluminescence, and radioluminescence;
a plurality of non-light-emitting elements; and
a binding element connecting the light-emitting elements and the non-light-emitting elements together along a linear axis, wherein an interconnect length of each light-emitting element and non-light emitting element measured along the linear axis is approximately equivalent, wherein the light-emitting elements and the non-light-emitting elements are arranged in an alternating light-dark pattern in which no two light-emitting elements are adjacently positioned and in which no two non-light-emitting elements are adjacently positioned, and wherein an approximately equivalent interconnect length is a length having a total variance among similar elements of fifteen percent or less.

20. The article of jewelry of claim 19, wherein each of the light-emitting elements is decorative ornaments having different distinctive shapes, and wherein a sum of the plurality of light-emitting elements and the plurality of non-light-emitting elements is at least seven.
